(19) United States
(12) Patent Application Publication
(10) Pub. No.: US 2026/0269209 A1
(43) Pub. Date: Sep. 10, 2026

(54) METHOD FOR MANUFACTURING A POROUS ELECTRODE, AND BATTERY CONTAINING SUCH AN ELECTRODE

(71) Applicant: I-TEN, Dardilly (FR)

(72) Inventor: Fabien GABEN, Dardilly (FR)

(73) Assignee: I-TEN, Dardilly (FR)

(21) Appl. No.: 18/722,788

(22) PCT Filed: Dec. 20, 2022
(86) PCT No.: PCT/IB2022/062522

§ 371 Date: Jun. 21, 2024

(30) Foreign Application Priority Data
Dec. 23, 2021 (FR) 2114453
Dec. 23, 2021 (FR) 2114458

(51) Int. Cl. H01M 4/04; H01M 4/02; H01M 4/131; H01M 4/1391; H01M 4/36; H01M 4/485; H01M 4/505; H01M 4/62; H01M 4/66

(52) U.S. Cl. CPC H01M 4/0404; H01M 4/0471; H01M 4/131; H01M 4/1391; H01M 4/366; H01M 4/485; H01M 4/505; H01M 4/628; H01M 4/662; H01M 2004/021

(57) ABSTRACT

The present disclosure relates to a porous electrode that can be used in electrochemical devices, such as a lithium-ion battery. This porous electrode includes a porous layer of at least one electrode active material P deposited on a substrate, and a coating made of electronically conductive oxide material present on and inside the pores of the porous layer of at least one electrode active material P.

### CROSS-REFERENCE TO RELATED APPLICATIONS

This application is a national phase entry of PCT Patent Application Serial No. PCT/IB2022/062522, filed on Dec. 20, 2022, which claims priority to French Patent Applications Serial Nos. FR2114453, filed on Dec. 23, 2021, and FR2114458, filed on Dec. 23, 2021, all of which are incorporated by reference herein.

### TECHNICAL FIELD

The invention relates to the field of electrochemistry, and more particularly thin-layer electrochemical devices. More specifically, it relates to electrodes that can be used in electrochemical devices such as capacitors, lithium-ion batteries, mini-batteries or lithium-ion batteries having a capacity greater than 1 mA h. The invention applies to negative electrodes and to positive electrodes. It concerns porous electrodes that may be impregnated with a solid electrolyte in liquid phase or with a liquid electrolyte.

The invention also relates to a method for preparing such a porous electrode that implements nanoparticles of an electrode material, and the electrodes thus obtained. The invention also relates to a method for manufacturing a lithium-ion battery comprising at least one of these electrodes and the batteries thus obtained.

### BACKGROUND

Lithium-ion batteries have the best energy density among the various electrochemical storage technologies proposed on the market. Various architectures and chemical compositions of electrodes exist making it possible to produce these batteries. The methods for manufacturing lithium-ion batteries are presented in numerous articles and patents; an inventory is given in the work “Advances in Lithium-Ion Batteries” (ed. W. van Schalkwijk and B. Scrosati), published in 2002 (Kluever Academic/Plenum Publishers).

There is a growing need for very small rechargeable batteries, capable of being integrated on electronic cards; these electronic circuits may be used in many fields, for example in cards for securing transactions, in electronic tags, in implantable medical devices, in various micromechanical systems.

There is also a growing need for large-capacity rechargeable batteries, particularly to power transport devices (electric bikes, scooter, electric motorbikes, electric cars, electric utility vehicles) and to store electrical energy, for example to store the electricity produced by intermittent electricity generators (wind turbines, photovoltaic panels) or to stabilise an electrical network subjected to a highly fluctuating supply and demand.

There is also a growing need for intermediate-size rechargeable batteries, for miscellaneous autonomous and portable devices (for example mobile phones, laptops, hand-held power tools, intermittent-use kitchen appliances).

In all of these applications, the possibility of rapid recharging of the battery is a highly appreciated feature. Likewise, these batteries must not present a risk of short-circuit or of fire. Finally, it is desirable that they are able to operate in a wide range of temperatures.

According to the prior art, the electrodes of lithium-ion batteries may be manufactured with the aid of covering techniques, particularly by coating. These methods make an ink possible to deposit on the surface of a substrate, the ink consisting of active material particles being in the form of powders; the particles constituting this powder have an average size of the particles that is typically between 5 μm and 15 μm in diameter.

These deposition techniques, particularly by coating, make it possible to produce layers of a thickness between approximately 50 μm and approximately 400 μm. The power and the energy of the battery may be modulated by adapting the thickness and the porosity of the layers, the size of the active particles that constitute them and by the presence of miscellaneous constituents within the layer such as binders or also electronically conductive materials. In order to produce microbatteries, it is desired to have a thinner thickness of each constitutive layer of the microbattery.

Apart from the problems related to the formulation of inks to obtain a high-performance electrode at low manufacturing cost, it should be kept in mind that the ratio between the energy density and the power density of the electrodes may be adjusted depending on the size of the active material particles, and indirectly on the porosity of the layers of electrodes and of their thickness. The article by J. Newman (“Optimization of Porosity and Thickness of a Battery Electrode by Means of A Reaction-Zone Model”, J. Electrochem. Soc., 142 (1), p. 97-101 (1995)) demonstrates the respective effects of the thicknesses of electrodes and of their porosity on their discharge (power) speed and energy density.

Mesoporous electrode layers without binder for lithium-ion batteries may be deposited by electrophoresis; this is known from WO 2019/215 407 (I-TEN). They may be impregnated with a liquid electrolyte, but their electrical resistivity remains fairly high.

In order to increase the low electronic conductivity of the electrodes, above all when these electrodes are of significant thicknesses or produced from not very electronically conductive electrode active materials, a certain quantity of electronically conductive material, such as carbon black, is generally added to the electrode active material particles. Ideally, the electronically conductive particles should be available in any point of the surface of the electrode active material particle in order to make it possible to simultaneously insert/deinsert electrode active particles over the entire surface, thus maximising the current density and minimising the local stress and heating due to an inhomogeneous electrical transport.

In practice, it is very difficult to control the arrangement of carbon black within the electrodes. In addition, with the growing use of increasingly smaller active material particles, these problems are even more dominant. An non uniform distribution of carbon black in the electrode induces a much higher polarisation of the electrode, which leads to an increase of the series resistance of the battery comprising such an electrode. These imbalances of local charge states will be all the more pronounced if the current density is high. These imbalances consequently induce a loss of cycling performance, a safety risk and a limitation of the power of the battery cell. The same applies when the electrodes have an inhomogeneous porosity, namely size distributed; this inhomogeneity contributes to making the wetting of the pores of the electrodes more difficult.

In this context and in order to reduce the electrical resistivity of mesoporous electrodes, the applicant has developed a mesoporous electrode comprising a mesoporous layer of at least one electrode active material having on and inside the pores of this mesoporous layer, a carbon coating; this is known from WO 2021/220 174 (I-TEN). The presence of this electronically conductive carbon coating on the electrode makes it possible to thereby reduce its electrical resistivity but does not make it possible to significantly increase its voltage withstand, temperature resistance and its electrochemical stability. In addition, the production of an electronically conductive carbon coating on the electrode is expensive and difficult to implement.

As there is a growing need for very small rechargeable batteries, the electrodes must meet increasingly drastic specifications. They must have a high chemical and electrochemical stability, solidity and corrosion resistance in such a way as to give the batteries that comprise them high cycling performances, storage stability, temperature stability, and long-term reliability. The present invention seeks to remedy at least partly the drawbacks of the prior art mentioned above.

More precisely, the problem that the present invention seeks to resolve is to provide a method for manufacturing porous electrodes having a homogeneous, high electronic conductivity and a controlled pore density that is simple, safe, rapid, easy to implement, inexpensive.

The present invention also aims to propose safe porous electrodes having a high electronic conductivity, a stable mechanical structure, a good thermal stability, above all at high temperature, a substantial service life, and this regardless of the thickness of the electrode.

Another aim of the invention is to propose electrodes for batteries capable of operating at high temperature without a problem of reliability and without the risk of fire. Another aim of the invention is to propose porous electrodes that, in addition to the preceding features, may be easily wetted and impregnated with an ionic liquid.

Another aim of the invention is to provide a method for manufacturing an electrochemical device such as a battery, a capacitor, a supercapacitor comprising a porous electrode according to the invention.

Another aim of the invention is to provide a method for manufacturing a battery having a capacity that does not exceed 1 mA h, here called “microbattery”, comprising a porous electrode according to the invention.

Yet another aim of the invention is to propose electrochemical devices such as batteries, particularly lithium-ion batteries and microbatteries, capacitors, supercapacitors capable of storing high energy densities, of restoring this energy with very high power densities (particularly in the capacitors or supercapacitors), of resisting high temperatures that have an excellent cycling service life as well as an improved safety.

### SUMMARY

In order to increase the performances of electrodes that can be used in conventional lithium-ion batteries, particularly by reducing their electrical resistivity while significantly increasing their voltage withstand, temperature resistance and their electrochemical stability the inventors have sought to find an alternative to the electronically conductive carbon coating presented in the application of WO 2021/220 174 (I-TEN).

According to the invention, the problem is resolved by an electrode for lithium-ion battery that is completely ceramic, mesoporous, devoid of organic binders, the porosity of which is between 25% and 50%, the size of the channels and pores of which is homogeneous in order to ensure a perfect dynamic balance of the cell. The electrode according to the invention comprises a porous, preferably mesoporous, layer of at least one electrode active material the porosity of which is between 25% and 50%, the size of the channels and pores of which is homogeneous in order to ensure a perfect dynamic balance of the cell, and having on and inside the pores of the porous layer, a coating of an electronically conductive oxide.

This porous, preferably mesoporous, layer, entirely solid, without organic components, is obtained by depositing, on a substrate, agglomerates and/or aggregates of nanoparticles of electrode active materials. The sizes of the primary particles constituting these agglomerates and/or aggregates are in the order of the nanometre or tens of nanometres, and the agglomerates and/or aggregates contain at least four primary particles. Said substrate may be, in a first embodiment, a substrate capable of acting as electric current collector, or be, in a second embodiment, a temporary, intermediate substrate, that will be explained in greater detail hereinafter.

The fact of using agglomerates of a few tens or even hundreds of nanometres in diameter rather than primary particles, not agglomerated with each one a size in the order of the nanometre or of the tens of nanometres makes it possible to increase the deposition thicknesses. The agglomerates must have a size less than 300 nm. The sintering of agglomerates of size greater than 500 nm would not make it possible to obtain a mesoporous continuous film. In this case, two different porosity sizes are observed in the deposition, namely a porosity between agglomerates and a porosity inside the agglomerates.

Indeed, it is observed that during the drying of the deposits of nanoparticles on a substrate capable of acting as electric current collector, cracks appear in the layer. It is noted that the appearance of these cracks essentially depends on the size of the particles, on the compactness of the deposition and on its thickness. This limit cracking thickness is defined by the following relation:

$${h}_{ma x} = 0.41 [ ( G M {∅}_{rcp} {R}^{3} ) / 2 γ ]$$

where hₘₐₓ designates the limit thickness, G designates the shear modulus of the nanoparticles, M designates the coordination number, Ø_{rcp} designates the volume fraction of nanoparticles, R designates the radius of the particles and γ designates the interfacial tension between the solvent and the air.

As a result, the use of agglomerates, mesoporous, consisting of primary nanoparticles at least ten times smaller than the size of the agglomerate, makes it possible to considerably increase the limit cracking thickness of the layers. In the same way, it is possible to add a few percent of a solvent with lower surface tension (such as isopropyl alcohol (abbreviated IPA)) in water or ethanol in order to improve the wettability and adherence of the deposition, and to reduce the risk of cracking. In order to increase the deposition thicknesses while limiting or even eliminating the appearance of cracks, it is possible to add binders, dispersants. These additives and organic solvents may be eliminated by a heat treatment in air, such as by debinding, during a sintering treatment or during a heat treatment performed prior to the sintering treatment.

Moreover, for the same size of primary particles when these particles are produced by hydrothermal synthesis, it is possible during their synthesis by precipitation to modify the size of the agglomerates by modulating the quantity of binders (for example polyvinylpyrrolidone, abbreviated PVP) in the synthesis reactor. Thus, an ink can be produced containing agglomerates highly dispersed in size or having two populations complementary in size, in such a way as to maximise the compactness of the deposit of agglomerates. As opposed to the sintering of non-agglomerated nanoparticles, the sintering conditions between the agglomerates of different sizes will not be modified. The primary nanoparticles are what constitute the agglomerates that will bond together. These primary nanoparticles have identical sizes regardless of the size of the agglomerate. The size distribution of the agglomerates will make it possible to improve the compactness of the deposits and to multiply the contact points between nanoparticles, but will not modify the consolidation temperature.

However, the agglomerates must remain small in order to be able to form during the heat treatment of the layer a mesoporous continuous film. If the agglomerates are too big this hinders their sintering and the formation of two distinct porosities in the layer is observed: a porosity between agglomerates and a porosity inside the agglomerates.

After sintering, a porous, preferably mesoporous, layer or a plate, without carbon black, or organic binders, is obtained, wherein all of the nanoparticles are bonded together (by the necking phenomenon, otherwise known) to form a mesoporous continuous network characterised by a unimodal porosity. The porous, preferably mesoporous, layer thus obtained is entirely solid and ceramic. There are no longer any risks of losses of electrical contact between the particles of active materials during the cycling which is likely to improve the cycling performances of the battery. Moreover, after sintering, the porous, preferably mesoporous, layer is perfectly adherent on the metal substrate on which it has been deposited or transferred (in the case of an initial deposition performed on an intermediate substrate).

The heat treatments performed at high temperature to sinter the nanoparticles together make it possible to perfectly dry the electrode and to eliminate any traces of water or of solvents or of other organic additives (stabilisers, binders) adsorbed at the surface of the active material particles. The heat treatment at high temperature (sintering) may be preceded by a heat treatment at lower temperature (debinding) to dry the electrode placed or deposited and to eliminate the traces of water or of solvents or of other organic additives (stabilisers, binders) adsorbed at the surface of the active material particles; this debinding may be carried out in oxidising atmosphere.

Depending on the sintering temperature and times, it is possible to adjust the porosity of the final electrode. Depending on the energy density needs, the latter may be adjusted in a range between 25% and 50% of porosity.

In all cases, the power density of the electrodes thus obtained remains extremely high due to the mesoporosity. Moreover, irrespectively of the size of the mesopores in the active material (knowing that after the sintering the notion of nanoparticle no longer applies to the material that then has a three-dimensional structure with a network of channels and of mesopores), the dynamic balance of the cell remains perfect, which contributes to maximising the power densities and service lives of the battery cell.

The electrode according to the invention has a high specific surface, which reduces the ionic resistance of the electrode. However, so that this electrode delivers a maximum of power, it is also necessary for it to possess a very good electronic conductivity to prevent the ohmic losses in the battery. This improvement of the electronic conductivity of the cell will be all the more critical when the thickness of the electrode will be high. Moreover, this electronic conductivity must be perfectly homogeneous in the entire electrode in order to prevent having locally more electrically resistive areas that could lead to the formation of a hot spot during the power operation of the battery.

According to an essential feature of the present invention, a coating of an electronically conductive oxide material is produced on and inside the pores of the porous layer. This electronically conductive oxide material may be deposited from a precursor of said electronically conductive oxide material, particularly from a liquid precursor of said electronically conductive oxide material.

Indeed, as explained above, the method according to the invention, which inevitably involves a step of depositing agglomerated nanoparticles of electrode material (active material), means that the nanoparticles naturally “bond” together to generate, after consolidation such as an annealing, a three-dimensional, rigid, porous structure, without organic binder; this porous, preferably mesoporous, layer is perfectly well adapted to the application of a surface treatment, by gaseous or liquid processes, which enters into the depth of the open porous structure of the layer.

A first object of the invention is a method for manufacturing a porous electrode, particularly for electrochemical devices, such as a battery, particularly a lithium-ion microbattery or a lithium-ion battery having a capacity greater than 1 mA h, said porous electrode comprising a porous layer of at least one electrode active material P deposited on a substrate, and a layer of an electronically conductive oxide material present on and inside the pores of said porous layer, said porous electrode being free of binder, having a porosity between 20% and 60% by volume, preferably between 25% and 50%, and pores of average diameter smaller than 50 nm, said manufacturing method being characterised in that:
(a) a substrate and a colloidal suspension or a paste is provided comprising aggregates or agglomerates of monodisperse primary nanoparticles, of at least one electrode active material P, of average primary diameter D₅₀ between 2 nm and 150 nm, preferably between 2 nm and 100 nm, and more preferably between 2 nm and 60 nm, said aggregates or agglomerates having an average diameter D₅₀ between 50 nm and 300 nm, and preferably between 100 nm to 200 nm, knowing that said substrate may be a substrate capable of acting as electric current collector, or be an intermediate substrate,
(b) a layer from said colloidal suspension or paste provided in step (a) is deposited on at least one face of said substrate, by a method selected in the group formed by: electrophoresis, extrusion, a printing method, preferably ink-jet printing or flexographic printing, a coating method, preferably by doctor blade, by roller, by curtain, by dip-coating, or by slot-die,
(c) said layer obtained in step (b) is dried, if applicable, before or after having separated said layer from its intermediate substrate, then optionally said dried layer is heat treated, preferably in oxidising atmosphere; then said layer is consolidated, by heat and/or mechanical treatment, preferably by sintering, to obtain a porous, preferably mesoporous, layer,
(d) a layer of an electronically conductive oxide material is formed, on and inside the pores of said porous layer, in such a way as to form a porous layer coated with a layer of an electronically conductive oxide material,
(e) optionally, an electronically insulating and ionically conductive layer is formed on and inside the pores of said porous layer coated with a layer of an electronically conductive oxide material obtained in step (d).
   In step (b) the deposition may be carried out on one or on the two faces of the substrate.

Advantageously, when said substrate is an intermediate substrate, said layer is separated in step (c) from said intermediate substrate, to form, particularly after consolidation, a porous plate. This separation step may be performed before or after drying the layer obtained in step (b).

Advantageously, when said substrate is an intermediate substrate, after step (c) and before step (d), an electrically conductive sheet is provided, covered on at least one face, respectively on its two faces, with a thin layer of conductive adhesive or with a thin layer of nanoparticles of at least one electrode active material P, then at least one porous plate is bonded on one face, preferably on each of the faces, of the electrically conductive sheet, in such a way as to obtain a porous, preferably mesoporous, layer or plate on a substrate capable of acting as current collector. In the present application, the terms “porous layer” and “porous plate” are interchangeable.

Advantageously, in step (d), during step (d1), a layer of a precursor of an electronically conductive oxide material is deposited on and inside the pores of said porous layer, and during step (d2), the transformation of the precursor of an electronically conductive oxide material, deposited during step (d1) on said porous layer, into an electronically conductive material, is performed, in such a way that said porous layer has on and inside the pores, a layer of said electronically conductive oxide material.

Advantageously, step (d1) is carried out by immersion of the porous layer in a liquid phase including a precursor of said electronically conductive oxide material, and said transformation of the precursor of an electronically conductive oxide material into an electronically conductive material, during step (d2), is performed by heat treatment such as a calcination, preferably performed in air or in oxidising atmosphere.

Advantageously, said precursor of the electronically conductive oxide material is selected from organic salts containing one or more metal elements capable, after heat treatment such as a calcination, of forming an electronically conductive oxide, and said transformation into electronically conductive material is a heat treatment such as a calcination, preferably performed in air or in oxidising atmosphere.

These organic salts are, preferably, selected from:
an alcoholate of at least one metal element capable, after heat treatment such as a calcination, preferably performed in air or in oxidising atmosphere, of forming an electronically conductive oxide,
an oxalate of at least one metal element capable, after heat treatment such as a calcination, preferably performed in air or in oxidising atmosphere, of forming an electronically conductive oxide, and
an acetate of at least one metal element capable, after heat treatment such as a calcination, preferably performed in air or in oxidising atmosphere, of forming an electronically conductive oxide, and/or preferably, the metal element is selected from tin, zinc, indium, gallium, or a mixture of two or three or four of these elements.

Advantageously, said porous layer obtained at the end of step (c) has a specific surface between 10 m²/g and 500 m²/g and/or a thickness between 4 μm and 400 μm.

Advantageously, when said colloidal suspension or paste provided in step (a) comprises organic additives, such as ligands, stabilisers, binders or residual organic solvents, said layer dried in step c) or said porous plate is heat treated, preferably in oxidising atmosphere.

Advantageously, said electrode active material P is selected in the group formed by:
oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths such as Sc, Y, Lu, La, Ce, Pr, Pm, Sm, Eu, Gd, Tb, Dy, Ho, Er, Tm, Yb, and where 0<x<0.1, LiMn₂₋ₓMₓO₄ with M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/2}O₂ with x+y+z=10;
LiₓM_{y}O₂ where 0.6≤y≤0.85; 0≤x+y≤2; and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
Li₁₊ₓNb_{y}Me_{z}AₚO₂ where Me is at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and where 0.6<x<1; 0<y<0.5; 0.25≤z<1; with A #Me and A #Nb, and 0≤p≤0.2;
LiₓNb_{y-a}NₐM_{z-b}P_{b}O_{2-c}F_{c} where 1.2<x≤1.75; 0≤y<0.55; 0.1<<<1; 0≤a<0.5; 0≤b<1; 0≤c<0.8; and where M, N, and P are each at least one of the elements selected in the group consisting of Ti, Ta, V, Cr, Mn, Fe, Co, Ni, Cu, Zn, Al, Zr, Y, Mo, Ru, Rh, and Sb;
Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43}Ni_{0.27}O₂; Li_{1.3}Nb_{0.43}Co_{0.27}O₂; Li_{1.4}Nb_{0.2}Mn_{0.53}O₂;
LiₓNi_{0.2}Mn_{0.6}O_{y} where 0.00≤x≤1.52; 1.07≤y<2.4; Li_{1.2}Ni_{0.2}Mn_{0.6}O₂;
LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z;
phosphates LiFePO₄, LiMnPO₄, LiCoPO₄, LiNiPO₄, Li₃V₂ (PO₄)₃, Li₂MPO₄F with M=Fe, Co, Ni or a mixture of these various elements, LIMPO₄F with M=V, Fe, T or a mixture of these various elements; phosphates of formula LiMM′PO₄, with M and M′ (M≠M′) selected from Fe, Mn, Ni, Co, V such as LiFeₓCo₁₋ₓPO₄ and where 0<x<1;
Fe_{0.9}Co_{0.1}OF; LiMSO₄F with M=Fe, Co, Ni, Mn, Zn, Mg; and
all of the lithiated forms of the following chalcogenides: V₂O₅, V₃O₈, TiS₂, titanium oxysulfides (TiO_{y}S_{z} with z=2-y and 0.3≤y≤1), tungsten oxysulfides (WO_{y}S_{z} with 0.6<y<3 and 0.1<z<2), CuS, CuS₂, preferably LiₓV₂O₅ with 0<<<2, LiₓV₃O₈ With 0<x≤1.7, LiₓTiS₂ with 0<x≤1, lithium and titanium oxysulfides LiₓTiO_{y}S_{z} with z=2-y, 0.3≤y≤1 and 0<x≤1, LiₓWO_{y}S_{z} with z=2-y, 0.3≤y≤1 and 0<x≤1, LiₓCuS with 0<x≤1, LiₓCuS₂ with 0<x≤1.

Advantageously, said aforementioned electrode active material P is used to manufacture a cathode.

Advantageously, said electrode active material P is selected in the group formed by:
Li₄Ti₅O₁₂, Li₄Ti₅₋ₓMₓO₁₂ with M=V, Zr, Hf, Nb, Ta and 0≤x≤0.25;
niobium oxides and niobium oxides mixed with titanium, germanium, cerium or tungsten, and preferably in the group formed by:
   Nb₂O_{5±δ}, Nb₁₈W₁₆O_{93±δ}, Nb₁₆W₅O_{55±δ} with 0≤x<1 and 0≤8≤2, LiNbO₃,
   TiNb₂O_{7±δ}, LiwTiNb₂O₇ with w≥0, Ti₁₋ₓM¹ₓNb_{2-y}M²_{y}O_{7±δ} or Li_{w}Ti₁₋ₓM¹ₓNb_{2-y}M²_{y}O_{7±δ} wherein M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, M¹ and M² may be identical to or different from one another, and wherein 0≤w≤5 and 0≤x≤1 and 0≤y≤2 and 0≤8≤0.3;
   LaₓTi₁₋₂ₓNb₂₊ₓO₇ where 0<x<0.5;
   MₓTi₁₋₂ₓNb₂₊ₓO_{7±δ}
      wherein M is an element the degree of oxidation of which is +III, more particularly M is at least one of the elements selected in the group consisting of Fe, Ga, Mo, Al, B, and where 0<x≤0.20 and −0.3≤0≤0.3; Ga_{0.10}Ti_{0.80}Nb_{2.10}O₇; Fe_{0.10}Ti_{0.80}Nb_{2.10}O₇;
   MₓTi₂₋₂ₓNb₁₀₊ₓO_{29±δ}
      wherein M is an element the degree of oxidation of which is +III, more particularly M is at least one of the elements selected in the group consisting of Fe, Ga, Mo, Al, B, and where 0<x≤0.40 and −0.3≤0≤0.3;
   Ti₁₋ₓM¹ₓNb_{2-y}M²_{y}O_{7-z}M³_{z} or Li_{w}Ti₁₋ₓM¹ₓNb_{2-y}M²_{y}O_{7-z}M³_{z} wherein
      M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
      M¹ and M² may be identical to or different from one another,
      M³ is at least one halogen,
      and wherein 0≤w≤5 and 0≤x≤1 and 0≤y≤2 and z≤0.3;
   TiNb₂O_{7-z}M³_{z} or Li_{w}TiNb₂O_{7-z}M³_{z} wherein M³ is at least one halogen, preferably selected from F, Cl, Br, I or a mixture thereof, and 0<z≤0.3;
   Ti₁₋ₓGeₓNb_{2-y}M¹_{y}O_{7±z}, Li_{w}Ti₁₋ₓGeₓNb_{2-y}M′_{y}O_{7±z}, Ti₁₋ₓCeₓNb_{2-y}M′_{y}O_{7±z}, Li_{w}Ti₁₋ₓCeₓNb_{2-y}M¹_{y}O_{7±z} wherein
      M¹ is at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn;
      0≤w≤5 and 0≤x≤1 and 0≤y≤2 and z≤0.3;
   Ti₁₋ₓGeₓNb_{2-y}M¹_{y}O_{7-z}M₂, Li_{w}Ti₁₋ₓGeₓNb_{2-y}M¹_{y}O_{7-z}M₂, Ti₁₋ₓCeₓNb_{2-y}M¹_{y}O_{7-z}M²_{z}, Li_{w}Ti₁₋ₓCeₓNb_{2-y}M¹_{y}O_{7-z}M²_{z}, wherein
      M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
      M¹ and M² may be identical to or different from one another,
      and wherein 0≤w≤5 and 0≤x≤1 and 0≤y≤2 and z≤0.3;
TiO₂; TiOₓN_{y} with x<2 and 0<y<0.2;
LiSiTON, silicon- and tin-based oxynitrides, and more particularly the formulation SiSn_{0.87}O_{1.20}N_{1.72} and their lithiated forms;
nitrides and oxynitrides of the MOₓN_{y} type where M is at least one element selected from Ge, Si, Sn, Zn or a mixture of one or more of these elements, and where x=0 and y=0.3;
Li₃₋ₓMₓN with M is at least one element selected from Cu, Ni, Co or a mixture of one or more of these elements;
Li₃₋ₓMₓN with M being cobalt (Co) and 0≤x≤0.5; Li₃₋ₓMₓN with M being nickel (Ni) and 0≤x≤0.6; Li₃₋ₓMₓN with M being copper (Cu) and 0≤x≤0.3;
carbon nanotubes, graphene, graphite;
lithiated iron phosphate (of typical formula LiFePO₄);
mixed silicon and tin oxynitrides, of typical formula SiₐSn_{b}O_{y}N_{z} with a>0, b>0, a+b≤2, 0<y≤4, 0<z≤3, also called SiTON, and in particular SiSn_{0.87}O_{1.2}N_{1.72}; as well as oxynitrides-carbides of typical formula SiₐSn_{b}C_{c}O_{y}N_{z} with a>0, b>0, a+b≤2, 0<c<10, 0<y<24, 0<z<17;
nitrides of the SiₓN_{y} type, in particular with x=3 and y=4; SnₓN_{y}, in particular with x=3 and y=4, ZnₓN_{y}, in particular with x=3 and y=2; Li₃₋ₓMₓN with 0≤x≤0.5 for M=Co, 0≤x≤0.6 for M=Ni, 0≤x≤0.3 for M=Cu; Si₃₋ₓMₓN₄ with M=Co or Fe and 0≤x≤3.
oxides SnO₂, SnO, Li₂SnO₃, SnSiO₃, LiₓSiO_{y} with x>=0 and 2≥y≥0, Li₄Ti₅O₁₂, TiNb₂O₇, CO₃O₄, SnB_{0.6}P_{0.4}O_{2.9} and TiO₂, and
composite oxides TiNb₂O₇ comprising between 0% and 10% by weight of carbon, preferably carbon being selected from graphene and carbon nanotubes.

Advantageously, said aforementioned electrode active material P is used to manufacture an anode.

Another object of the invention is a porous electrode, particularly for electrochemical devices, comprising a porous layer of at least one electrode active material P deposited on a substrate, and a layer of an electronically conductive oxide material disposed on and inside the pores of said porous layer, in that it is free of binder, that it has a porosity between 20% and 60% by volume, preferably between 25% and 50%, and pores of average diameter smaller than 50 nm.

Another object of the invention is a porous electrode obtainable by the method according to the invention characterised in that the porous electrode comprises a porous layer of at least one electrode active material P deposited on a substrate, and a layer of an electronically conductive oxide material disposed on and inside the pores of said porous layer, in that it is free of binder, that it has a porosity between 20% and 60% by volume, preferably between 25% and 50%, and pores of average diameter smaller than 50 nm.

Another object of the invention is a method for manufacturing an electrochemical device, such as a battery, a capacitor, a supercapacitor, a photoelectrochemical cell, or an electronic device, such as a photovoltaic cell, implementing the method for manufacturing a porous electrode according to the invention or implementing a porous electrode according to the invention.

Another object of the invention is a method for manufacturing an electronic or electrochemical device, such as a battery, a capacitor, a supercapacitor, a photoelectrochemical cell, a photovoltaic cell, and particularly a method for manufacturing a lithium-ion battery, such as a microbattery or a lithium-ion battery having a capacity greater than 1 mA h, implementing the method for manufacturing a porous electrode according to the invention or implementing a porous electrode according to the invention.

In particular, this method lends itself well to the manufacture of batteries, and generally, the battery according to the invention may be designed and sized in such a way as to have a capacity less than or equal to 1 mA h and up to approximately 1 mA h (commonly called “microbattery”), or it may be designed and sized in such a way as to have a larger capacity, greater than 1 mA h or even significantly greater than this value. Typically, the microbatteries, but also some batteries of larger capacity, are designed as surface-mounted components (a technology commonly abbreviated “SMT”, Surface-Mount Technology), in such a way as to be compatible with the manufacturing methods of microelectronics, particularly with the robotised methods for assembling electronic cards known under the term “pick and place”.

Advantageously, said porous electrode is impregnated with an electrolyte, preferably a lithium-ion carrier phase selected in the group formed by:
an electrolyte consisting of at least one aprotic solvent and of at least one lithium salt;
an electrolyte consisting of at least one ionic liquid and of at least one lithium salt;
a mixture of at least one aprotic solvent and of at least one ionic liquid and of at least one lithium salt;
a polymer made ionically conductive by adding at least one lithium salt; and
a polymer made ionically conductive by adding a liquid electrolyte, either in the polymer phase, or in the mesoporous structure.

Another object of the invention is a battery, preferably a lithium-ion battery, obtainable by the method according to the invention.

Generally, the battery according to the invention may be a microbattery, the capacity of which is less than approximately 1 mA h, a mini-battery, the capacity of which is greater than 1 mA h and up to approximately 1 A h, or a battery the capacity of which is greater than 1 A h. Indeed, the method according to the invention lends itself particularly well to the production of layers of a thickness greater than 1 μm or even greater than 5 μm, while ensuring a low series resistance of the battery.

Another object of the invention is an electronic or electrochemical device, such as a battery, a capacitor, a supercapacitor, a photovoltaic cell, comprising a porous electrode according to the invention or obtainable by the method according to the invention.

### DETAILED DESCRIPTION

### 1. Definitions

The present invention relates to a porous electrode the accessible surface of which, i.e. the outer surface of the electrode as well as the inside of the accessible pores of the electrode, is coated with an electronically conductive oxide material. The term “electronically conductive oxide” comprises electronically conductive oxides and electronically semi-conductive oxides.

Within the scope of the present document, the size of a particle is defined by its largest dimension. “Nanoparticle” means any particle or object of nanometric size that has at least one of its dimensions less than or equal to 100 nm.

“Ionic liquid” means any liquid salt, capable of transporting electricity, being differentiated from all molten salts by a melting temperature less than 100° C. Some of these salts remain liquid at ambient temperature and do not solidify, even at very low temperature. Such salts are called “ambient temperature ionic liquids”.

“Mesoporous” materials means any solid that has within its structure pores referred to as “mesopores” possessing an intermediate size between that of micropores (width less than 2 nm) and that of macropores (width greater than 50 nm), namely a size between 2 nm and 50 nm. This terminology corresponds to that adopted by IUPAC (International Union for Pure and Applied Chemistry), which is a reference for the person skilled in the art. Therefore, the term “nanopore” is not used here, even if the mesopores such as defined above have nanometric dimensions within the meaning of the definition of nanoparticles, knowing that the pores of size less than that of mesopores are called “micropores” by the person skilled in the art.

A presentation of the concepts of porosity (and of the terminology that has just been disclosed above) is given in the article “Texture des matériaux pulvérulents or poreux” by F. Rouquerol and al., published in the collection “Techniques de l′Ingénieur”, traité Analyse et Caractérisation, fascicule P 1050; this article also describes the techniques for characterising porosity, particularly the BET method.

Within the meaning of the present invention, “porous layer” means a layer that has pores. “Mesoporous layer” means a layer that has mesopores. In these layers, the pores and the mesopores contribute significantly to the total porous volume; this is referred to using the expression “Porous/mesoporous layers of porosity greater than X % by volume” used in the present description.

The term “aggregate” means, according to the definitions of the IUPAC a weakly linked assembly of primary particles. To be precise, these primary particles are nanoparticles having a diameter that can be determined by transmission electron microscopy. An aggregate of aggregated primary nanoparticles can normally be destroyed (i.e. reduced to primary nanoparticles) in suspension in a liquid phase under the effect of ultrasounds, according to a technique known by the person skilled in the art.

The term “agglomerate” means, according to the definitions of the IUPAC a strongly linked assembly of primary particles or aggregates.

### 2. Preparation of Suspensions of Nanoparticles

The porous electrodes according to the invention are developed from a colloidal suspension of clusters and/or of agglomerates of nanoparticles or a paste.

In an even more preferred embodiment of the invention, the nanoparticles are prepared directly at their primary size by precipitation, Pechini synthesis, hydrothermal or solvothermal synthesis; this technique makes it possible to obtain nanoparticles with a very narrow size distribution, called “monodisperse nanoparticles”. The size of these non-aggregated or non-agglomerated nanopowders/nanoparticles is called the primary size. It is typically between 2 nm and 150 nm. It is advantageously between 10 nm and 50 nm, preferably between 10 nm and 30 nm; this favours during later steps of the method the formation of an interconnected mesoporous network with electronic and ionic conduction, thanks to the “necking” phenomenon.

Binders may also be added in the suspension of nanoparticles (clusters and/or agglomerates of nanoparticles, knowing that these clusters are also in the form of nanoparticles) to facilitate the production of deposits or green strips, particularly of thick deposits without cracks.

This is a colloidal suspension or a paste comprising aggregates or agglomerates of nanoparticles that is subsequently used for the manufacture of a dried porous layer of an electrode active material P.

### 3. Manufacture of a Porous Layer

The method for manufacturing an electrode according to the invention includes the application of such a colloidal suspension or paste comprising aggregates or agglomerates of primary monodisperse nanoparticles of at least one electrode active material P, on a substrate to form a layer, then the drying of said layer in order to obtain a porous layer. This sequence comprising the application of this colloidal suspension or paste on a substrate to form a layer and its drying may be repeated a plurality of times in order to increase the thickness of the porous layer. The final thickness of this porous layer, is advantageously less than or equal to 5 mm, preferably between approximately 1 μm and approximately 500 μm. The thickness of this porous layer is advantageously less than 300 μm, preferably, between approximately 5 μm and approximately 300 μm, preferably between 5 μm and 150 μm. Generally, the colloidal suspension or paste is deposited on a substrate, by any appropriate technique, and in particular by electrophoresis, by extrusion, by the ink-jet printing method hereinafter ink-jet, by spraying, by flexographic printing, by a coating method, preferably by doctor blade or tape casting, by roll coating, by curtain coating, by slot-die, or by dip-coating.

So that the colloidal suspension or paste (ink), has a viscosity adapted to the coating techniques usually employed for the manufacture of electrodes, and thus can be deposited on a substrate, it is advantageous to use a colloidal suspension or paste having a dry extract less than 30% by weight.

According to the observations of the applicant, with an average diameter of aggregates or agglomerates of nanoparticles between 80 nm and 300 nm (preferably between 100 nm to 200 nm), during subsequent steps of the method, a mesoporous layer is obtained having an average diameter of the mesopores between 2 nm and 50 nm.

According to the invention, the porous layer of at least one electrode active material P may be deposited by ink-jet or by a coating method, and particularly by dip-coating, by roll coating, by curtain coating, by slot-die, or also by doctor blade, and this from a fairly concentrated suspension comprising aggregates or agglomerates of nanoparticles of the active material P.

The porous electrode layer may also be deposited by electrophoresis, but then advantageously a less concentrated suspension is used containing agglomerates of nanoparticles of the active material P.

The methods for depositing aggregates or agglomerates of nanoparticles by electrophoresis, by extrusion, by dip-coating, by ink-jet, by roll coating, by curtain coating, by slot-die or by doctor blade are methods that are simple, safe, easy to implement, to industrialise and that make it possible to obtain a homogeneous final porous layer. Electrophoretic deposition makes it possible to uniformly deposit layers over large surfaces with high deposition speeds. Coating techniques, particularly those mentioned above, make it possible to simplify the management of the baths in relation to the electrophoretic deposition techniques because the suspension does not become poorer in particles during the deposition. Ink-jet deposition makes it possible to carry out localised depositions.

Porous layers in a thick layer may be produced in a single step by roll coating, by curtain coating, by slot die coating, or by doctor blade.

The technique for depositing the colloidal suspension or paste (ink), and the behaviour of the deposition method must be compatible with the viscosity of the colloidal suspension or paste (ink) used, and vice versa.

The substrate is advantageously an intermediate substrate or a substrate that may be used as current collector.

### 3.1 Substrate Capable of Acting as Current Collector

In a first embodiment, said substrate is a substrate capable of acting as electric current collector. The substrate may advantageously be a metal substrate or an electronically conductive carbon substrate, particularly based on graphite, graphene and/or carbon nanotubes. Said substrate on which the colloidal suspension or paste (ink) is deposited ensures for the electrode the function of current collector. The colloidal suspension or paste (ink) may be deposited on one or on the two faces of the substrate, particularly by the deposition techniques indicated above.

The current collector within electrochemical devices employing electrodes according to the invention may be a stable substrate in the range of operating potential of the electrochemical device. Within batteries employing electrodes according to the invention, the current collector must be a stable substrate in a potential range, preferably between 2.5 V and 5 V for the cathode and between 0 V and 2.5 V for the anode, in relation to the potential of lithium. Advantageously, a metal substrate is selected, for example a metal strip (i.e. a laminated metal sheet). The substrate may particularly be made of tungsten, molybdenum, chromium, titanium, tantalum, zirconium, niobium, stainless steel, or an alloy of two or more of these materials. Such metal substrates are fairly expensive and may greatly increase the cost of the battery. Tungsten, molybdenum, chromium, titanium, tantalum, zirconium, niobium, stainless steel and their alloys are particularly resistant to heat treatments at high temperature; they are thus particularly well adapted as sintered electrode substrate.

It is also possible to coat this substrate capable of acting as current collector, with a conductive or semi-conductive oxide before depositing the colloidal suspension or paste (ink), which makes it possible to particularly protect less noble substrates such as copper, nickel, aluminium and carbon, particular in the form of graphite. These less noble substrates may thus be used as electrode substrate. This may concern a conductive carbon sheet (typically made of graphite), a metal sheet, or a metallised (i.e. coated with a metal layer) non-metal sheet. The substrate is preferably selected from strips made of copper, of nickel, of molybdenum, of tungsten, of tantalum, of chromium, niobium, zirconium, titanium, and from alloy strips including at least one of these elements. It is also possible to use stainless steel. These substrates have the advantage of being stable in a wide potential range and resistant to heat treatments.

Copper, nickel, molybdenum and their alloys are preferably used as anodic substrate. The substrates based on carbon, particularly in the form of graphite, based on alloys of nickel-chromium, of stainless steels, of chromium, of titanium, of aluminium, of tungsten, of molybdenum, of tantalum, of zirconium, of niobium or on alloys containing at least one of these elements are, preferably, used as cathode electric current collector substrate. These anodic and/or cathodic substrates may or may not be coated with an electrochemically inert and conductive layer. Such layers may be produced by deposition of nitrides, of carbides, of graphites, of gold, of palladium and/or of platinum.

The colloidal suspension or paste (ink) may be deposited on one or on the two faces of the substrate capable of acting as current collector. The layer deposited on this substrate is subsequently dried in such a way as to obtain a porous layer of an electrode active material P.

This porous layer of an electrode active material P thus dried is subsequently consolidated. This consolidation may be performed by pressing and/or heat treatment, i.e. by a heat treatment (heating), by a heat treatment preceded by a mechanical treatment, and optionally by a thermomechanical treatment, typically a thermocompression. In a very advantageous embodiment of the invention this treatment leads to a partial coalescence of the primary nanoparticles in the aggregates, or the agglomerates, and between neighbouring aggregates or agglomerates; this phenomenon is called “necking” or “neck formation”. It is characterised by the partial coalescence of two particles in contact, which remain separated but connected by a neck (shrinkage). The lithium ions and the electrons are mobile within these necks and may diffuse from one particle to the other without encountering grain boundaries. The nanoparticles are bonded together to ensure the conduction of electrons from one particle to the other. Thus a rigid, continuous mesoporous film, without organic binder is formed from the primary nanoparticles, forming a three-dimensional network with strong ion mobility and electronic conduction; this network includes interconnected pores, preferably mesopores. This porous, preferably mesoporous, layer thus obtained, is perfectly well adapted to the application of a surface treatment, by gaseous or liquid processes, which enters into the depth of the open porous structure of the layer.

The temperature needed to obtain “necking” depends on the material; in light of the diffusive nature of the phenomenon that leads to necking, the duration of the treatment depends on the temperature. This method may be called sintering; according to its duration and its temperature a more or less pronounced coalescence (necking) is obtained, which has an effect on the porosity. It is thus possible to obtain an electrode of ceramic porous or mesoporous structure sought of controlled porosity while conserving a perfectly homogeneous channel size. During this heat or thermomechanical treatment, the electrode layer will be cleared of any constituent and organic residue (such as the liquid phase of the suspension of nanoparticles, the binders and any surface active products): it becomes an inorganic layer (ceramic).

According to an essential feature of the present invention, a coating of an electronically conductive oxide material is produced, on and inside the pores of said porous layer, i.e. on the accessible surface of said porous layer, as will be explained later in Paragraph 3.3.

### 3.2 Intermediate Substrate

According to a second embodiment, the colloidal suspension or paste (ink) is not deposited on a substrate capable of acting as electric current collector, but on an intermediate substrate, which is typically used temporarily.

In this embodiment, the colloidal suspension or paste (ink) is deposited on a face of the intermediate substrate, in such a way as to be able to later easily separate the layer obtained from this intermediate substrate.

In particular, it is possible to deposit, from a suspension in nanoparticles and/or agglomerates of nanoparticles of electrode active material P, preferably from a concentrated suspension containing nanoparticles of electrode active material P (i.e. less fluid, preferably pasty), fairly thick layers (called green sheets). These thick layers may be deposited by any appropriate means, particularly by ink-jet, by spraying, by flexographic printing, by a coating method, preferably by doctor blade, by roll coating, by curtain coating, by slot-die, or by dip-coating.

The methods for depositing nanoparticles, by the method of dip-coating, by ink-jet, by roll coating, by curtain coating, by slot-die, by spraying, by flexographic printing or by doctor blade are methods that are simple, safe, easy to implement, to industrialise and that make it possible to obtain a homogeneous deposit. Ink-jet makes it possible to deposit the colloidal suspension or paste (ink) locally, in the same way as the depositions by doctor blade. Thick layers may be obtained in a single step by the techniques of roll-coating, curtain coating, slot-die, dip-coating or doctor blade.

Said intermediate substrate may be a flexible substrate, which may be a polymer sheet, for example polyethylene terephthalate, abbreviated PET. In this second embodiment, the deposition step is carried out, advantageously, on a face of said intermediate substrate in order to facilitate the subsequent separation of the layer from its substrate. In this second embodiment, it is possible to separate the layer from its substrate before or after drying, preferably after drying and before any heat treatment. The thickness of the layer after drying, is advantageously less than or equal to 5 mm, advantageously between approximately 1 μm and approximately 500 μm. The thickness of the layer after drying, i.e. of the non-sintered electrode, is advantageously less than 300 μm, preferably, between approximately 5 μm and approximately 300 μm, preferably between 5 μm and 150 μm.

In said second embodiment, the method for manufacturing an electrode for electrochemical device such as a battery uses an intermediate substrate made of polymer (such as PET) and leads to a strip referred to as “green strip”. This green strip is subsequently separated from its substrate; it then forms self-supporting plates or sheets (here the term “plate” is subsequently used, regardless of its thickness).

These self-supporting porous sheets or plates are subsequently dried. After drying, these self-supporting sheets or plates may subsequently be heat treated, preferably in oxidising atmosphere, if necessary, in order to eliminate the organic constituents. These self-supporting sheets or plates are subsequently consolidated, as explained above in Paragraph 3.1.

These plates thus sintered have a thickness advantageously less than or equal to 5 mm, preferably between approximately 1 μm and approximately 500 μm. The thickness of the porous plate after sintering is advantageously less than 300 μm, preferably, between approximately 5 μm and approximately 300 μm, preferably between 5 μm and 150 μm.

According to the second embodiment and in order to obtain a porous electrode disposed on a substrate capable of acting as current collector, an electrically conductive sheet is provided, covered on at least one of its faces, preferably on its two faces, with an intermediate thin layer of nanoparticles of the electrode active material P, preferably identical to those constituting the plate, or covered on at least one of its faces, preferably on its two faces with a thin layer of conductive adhesive (charged with graphite) or with a deposit of the sol-gel type charged with conductive particles. Said thin layers have, preferably, a thickness less than 1 μm. This electrically conductive sheet may be a metal strip or a graphite sheet.

When said electrically conductive sheet is metal, it is preferably a laminated sheet, i.e. obtained by lamination. The lamination may optionally be followed by a final annealing, which may be a soft (full or partial) or recrystallisation annealing, according to the terminology of metallurgy. It is also possible to use an electrochemically deposited sheet, for example an electrodeposited copper sheet or an electrodeposited nickel sheet.

This electrically conductive sheet is subsequently disposed on a plate or inserted between two plates obtained beforehand after drying and optionally heat treatment (i.e. sintering). The whole is subsequently thermopressed in such a way that said intermediate thin layer of nanoparticles transforms by sintering and comes to consolidate the plate/substrate or plate/substrate/plate assembly to obtain a rigid and one-piece sub-assembly. During this sintering the bond between the plate and the intermediate layer establishes by diffusion bonding. This assembling is carried out with two plates, preferably produced from the same nanoparticles of the electrode active material P, and the metal sheet disposed between these two plates.

One of the advantages of the second embodiment is that it makes it possible to use inexpensive substrates such as aluminium strips, copper or graphite strips. Indeed, these strips do not resist the heat treatments for consolidating the layers deposited; the fact of bonding them on the plates after their heat treatment also makes it possible to prevent them from oxidising.

This diffusion bonding assembly may be performed separately as has just been described, and the plate/substrate or plate/substrate/plate sub-assemblies thus obtained, once coated by a layer of a electronically conductive oxide material, will be able to be used in the manufacture of an electrochemical device such as a battery.

### 3.3 Production of a Coating or a Layer of an Electronically Conductive Oxide Material on and Inside the Porous Layer or Porous Plate

According to an essential feature of the present invention, after drying and consolidation, an electronically conductive oxide coating is produced on and inside the pores of these porous layers, porous plates or self-supporting porous sheets (hereinafter indifferently called porous layers or porous plates), i.e. on the accessible surface of these porous layers or porous plates, so that they can be used as porous electrodes, particularly in electrochemical devices such as in batteries, microbatteries or capacitors.

The fact of using an electronically conductive coating in oxide form instead of a carbon coating gives, among other things, a better performance to the final electrode. Indeed, the presence of this electronically conductive oxide layer on and inside the pores of the porous plate or layer, particularly due to the fact that the electronically conductive coating is in oxide form, makes it possible to improve the final properties of the electrode, particularly to improve the voltage withstand of the electrode, its temperature resistance, to improve the electrochemical stability of the electrode, particularly when it will be in contact with a liquid electrolyte, to reduce the polarisation resistance of the electrode, and this even when the electrode is thick. It is essentially the synergic combination of a porous plate or layer developed from an electrode active material, and from an electronically conductive coating in oxide form disposed on and inside the pores of said porous plate or layer that makes it possible to improve the final properties of the electrode, particularly to obtain thick electrodes without increasing the internal resistance of the electrode.

Very advantageously, the layer of electronically conductive oxide material may be obtained in various ways, particularly by the Atomic Layer Deposition (ALD) technique or by immersion in a liquid phase including a precursor of the electronically conductive oxide material followed by the transformation of said precursor of an electronically conductive material into electronically conductive material, in particular by heat treatment. More generally, with the techniques for producing the coating of an electronically conductive oxide material indicated here, only the free surfaces of the pores are covered, particularly the accessible surfaces of the porous plate or layer and those of the substrate. The “bonding” area between the porous layer and the substrate is not covered by the electronically conductive oxide material. The techniques indicated here make it possible to obtain a constant thickness of said layer of an electronically conductive oxide material within the porous, preferably mesoporous, plate or layer. Its thickness is typically between 0.5 nm and 10 nm, preferably less than 2 nm.

The ALD techniques are particularly well adapted to cover, layer by layer, by a cyclic method, rigid surfaces having a significant roughness in a totally sealing and conformal way. They make it possible to produce conformal layers (fully covering) of very thin thickness, free of defects, such as holes (layers referred to as “pinhole free”). However, before carrying out any deposition by the atomic layer deposition (ALD) technique, it is necessary to eliminate beforehand, on the surface of the porous layer, any trace of organic compounds. As ALD is typically performed at a temperature between 100° C. and 300° C., the residual organic matter, such as organic binders, would risk, within this temperature range, breaking down and polluting the ALD reactor. Moreover, the growth of the layer deposited by ALD is influenced by the nature of the substrate. A layer deposited by ALD on a substrate having various areas of different chemical natures will have an inhomogeneous growth that could generate a loss of integrity.

A layer of an electronically conductive material may be formed, very advantageously, by immersion in a liquid phase including a precursor of said electronic conductive material followed by the transformation of said precursor of an electronically conductive material into electronically conductive material by heat treatment. This method is simple, rapid, easy to implement and is less expensive than the atomic layer deposition (ALD) technique. Advantageously, said precursor of the electronically conductive material is selected from organic salts containing one or more metal elements capable, after heat treatment such as a calcination, preferably performed in air or in oxidising atmosphere, of forming an electronically conductive oxide. These metal elements, preferably these metal cations, may advantageously be selected from tin, zinc, indium, gallium, or a mixture of two or three or four of these elements. The organic salts are preferably selected from an alcoholate of at least one metal element capable, after heat treatment such as a calcination, preferably performed in air or in oxidising atmosphere, of forming an electronically conductive oxide, an oxalate of at least one metal element capable, after heat treatment such as a calcination, preferably performed in air or in oxidising atmosphere, of forming an electronically conductive oxide, and an acetate of at least one metal element capable, after heat treatment such as a calcination, preferably performed in air or in oxidising atmosphere, of forming an electronically conductive oxide.

Advantageously, said electronically conductive material may be an electronically conductive oxide material, preferably selected from:
tin oxide (SnO₂), zinc oxide (ZnO), indium oxide (In₂O₃), gallium oxide (Ga₂O₃), a mixture of two of these oxides such as indium-tin oxide corresponding to a mixture of indium oxide (In₂O₃) and of tin oxide (SnO₂), a mixture of three of these oxides or a mixture of four of these oxides,
doped oxides based on zinc oxide, the doping being preferably with gallium (Ga) and/or with aluminium (Al) and/or with boron (B) and/or with beryllium (Be), and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped oxides based on indium oxide, the doping being preferably with tin (Sn), and/or with gallium (Ga) and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped tin oxides, the doping being preferably with arsenic (As) and/or with fluorine (F) and/or with nitrogen (N) and/or with niobium (Nb) and/or with phosphorus (P) and/or with antimony (Sb) and/or with aluminium (Al) and/or with titanium (Ti), and/or with gallium (Ga) and/or with chromium (Cr) and/or with cerium (Ce) and/or with indium (In) and/or with cobalt (Co) and/or with nickel (Ni) and/or with copper (Cu) and/or with manganese (Mn) and/or with germanium (Ge).

In order to obtain a layer of an electronically conductive material, preferably of an electronically conductive oxide material, from an alcoholate, from an oxalate or from an acetate, the porous layer may be immersed in a rich solution of the precursor of the desired electronically conductive material. Subsequently, the electrode is dried and subjected to a heat treatment, preferably in air or in oxidising atmosphere, at a temperature sufficient to transform the precursor of the electronically conductive material of interest into electronically conductive material. Thus, a coating of the electronically conductive material is formed, preferably a coating of an electronically conductive oxide material, more preferably made of SnO₂, ZnO, In₂O₃, Ga₂O₃, or indium-tin oxide, over the entire inner surface of the electrode, perfectly distributed.

The presence of an electronically conductive coating in oxide form instead of a carbon coating on and inside the pores of the porous layer gives the electrode better electrochemical performances at high temperature, and makes it possible to significantly increase the stability of the electrode. The fact of using an electronically conductive coating in oxide form instead of a carbon coating gives, among other things, a better performance to the final electrode. Indeed, the presence of this electronically conductive oxide layer on and inside the pores of the porous plate or layer, particularly due to the fact that the electronically conductive coating is in oxide form, makes it possible to improve the final properties of the electrode, particularly to improve the voltage withstand of the electrode, its temperature resistance, to improve the electrochemical stability of the electrode, particularly when it will be in contact with a liquid electrolyte, to reduce the polarisation resistance of the electrode, and this even when the electrode is thick. It is particularly advantageous to use an electronically conductive coating in oxide form, particularly of the type In₂O₃, SnO₂, ZnO, Ga₂O₃ or a mixture of one or more of these oxides, on and inside the pores of the porous layer of an electrode active material, when the electrode is thick, and/or when the active materials of the porous layer are too resistive.

The electrode according to the invention is porous, preferably mesoporous and is specific surface is large. Increasing the specific surface of the electrode multiplies the exchange surfaces, and consequently, the power of the battery, but it also accelerates the parasitic reactions. The presence of these electronically conductive coatings in oxide form on and inside the pores of the porous layer will make it possible to block these parasitic reactions.

Moreover, due to the very large specific surface, the effect of these electronically conductive coatings in oxide form on the electronic conductivity of the electrode will be much more pronounced than in the case of a conventional electrode, where the specific surface is smaller, and this, even if the conductive coatings deposited have a low thickness. These electronically conductive oxide coatings, deposited on and inside the pores of the porous layer give the electrode an excellent electronic conductivity, particularly when the porous layer is developed from not very electronically conductive electrode active material. This layer of electronically conductive oxide material makes it possible to improve the electrical conductivity of the electrode while limiting the dissolution of the electrode and also makes it possible to increase the power of the battery; this is all the truer when the coating layer of electronically conductive oxide material has a low thickness.

It is essentially the synergic combination of a porous plate or layer developed from an electrode active material, and from an electronically conductive coating in oxide form disposed on and inside the pores of said porous plate or layer that makes it possible to improve the final properties of the electrode, particularly to obtain thick electrodes without increasing the internal resistance of the electrode.

Moreover, the electronically conductive coating in oxide form on and inside the pores of a porous layer is easier and less expensive to produce than a carbon coating. Indeed, in the case of coatings made of electronically conductive material in oxide form, the transformation of the precursor of the electronically conductive material into electronically conductive coating does not need to be performed in inert atmosphere as opposed to the carbon coating.

This coating of a coating electronically conductive oxide material typically has a thickness less than 10 nm, preferably less than 5 nm and more preferably less than 2 nm. This coating gives the electrode a good electronic conduction, regardless of its thickness. The fact of using an electronically conductive coating in oxide form instead of a carbon coating gives, particularly a better performance to the final electrode. It is noted that the formation of this coating of an electronically conductive oxide material is possible after sintering because the electrode is completely solid, without organic residues, and resists thermal cycles imposed by the various heat treatments.

Optionally, it is possible to deposit on top of this layer of an electronically conductive oxide material a layer that is electronically insulating and that has a good ionic conductivity; its thickness is typically in the order of 0.5 nm to 20 nm, preferably less than 5 nm, and also more preferably less than 2 nm.

Said electronically insulating and ionically conductive layer may be of inorganic or organic nature. More particularly, among the inorganic layers it is possible to use for example an oxide, a phosphate or a borate that conducts lithium ions, and among the organic layers it is possible to use polymers (for example PEO optionally containing lithium salts, or a sulfonated tetrafluoroethylene copolymer such as Nafion™, CAS no. 31175-20-9).

This electronically insulating and ionically conductive layer makes it possible to limit the dissolution of ions originating from the electrode and their migration to the electrolyte, knowing that in the electrodes made of LiMn₂O₄ manganese risks dissolving in certain liquid electrolytes, particularly at high temperature.

When the layer of electronically conductive oxide material is covered with an ionically conductive layer, the latter will mainly ensure the protection functions, as described above (particularly to prevent the dissolution of the electrode).

To sum up, with these coatings deposited on and inside the pores of the porous electrode layer, it is sought to obtain two effects: the increase of the electronic conductivity and the protection against the dissolution in the electrolyte at high temperature. Either these two effects are obtained with only the layer made of electronically conductive oxide material, or only one coating is not sufficient to obtain the two effects in which case it is possible to deposit two layers, for example, a first layer of an electronically conductive oxide material according to the invention to obtain the electronic conduction and a second, electronically insulating and ionically conductive, layer; to obtain an additional protection at high temperature.

According to the first and the second embodiment, a porous electrode according to the invention is obtained, disposed on a metal substrate used as electronic current collector or located on either side of the metal substrate used as electronic current collector. The electrode/substrate/electrode sub-assemblies thus obtained, by the first or the second embodiment, may be used in the manufacture of an electrochemical device such as a battery, and particularly a microbattery. An assembly by diffusion bonding may also be performed by stacking and thermopressing the entire structure of the electrochemical device (such as a battery and particularly a microbattery); in this case a multilayer stack is assembled comprising a first anode according to the invention, its metal substrate, a second anode according to the invention, a solid electrolyte layer, a first cathode according to the invention, its metal substrate, a second cathode according to the invention, a new solid electrolyte layer, and so on.

This electrode/substrate/electrode sub-assembly may be used to manufacture electrochemical devices such as batteries (and particularly microbatteries). Regardless of the embodiment of the electrode/substrate/electrode sub-assembly, on the latter the electrolyte film is subsequently deposited. Cut-outs are subsequently made to produce a battery with a plurality of elementary cells, then the sub-assemblies are stacked (typically in “head-to-tail” mode) and the thermocompression is performed to bond the anodes and cathodes together at the solid electrolyte.

Alternatively, the cut-outs needed to produce a battery with a plurality of elementary cells may be made, before depositing an electrolyte film, on each anode/substrate/anode and cathode/substrate/cathode sub-assembly. Subsequently, the anode/substrate/anode sub-assemblies and/or the cathode/substrate/cathode sub-assemblies are coated with an electrolyte film, then the sub-assemblies are stacked (typically in “head-to-tail” mode) and the thermocompression is performed to bond the anodes and the cathodes together at the electrolyte film.

In the two variants that have just been presented, the thermocompression bonding is carried out at a relatively low temperature, which is possible thanks to a very small size of nanoparticles. Therefore, no oxidation of the metal layers of the substrate is observed.

### EXAMPLES

### Example 1: Production of a Mesoporous Cathode Based on LiMn₂O₄ According to the Invention

A suspension of nanoparticles of LiMn₂O₄ was prepared by hydrothermal synthesis according to the method described in the article by Liddle et al. entitled “A new one pot hydrothermal synthesis and electrochemical characterisation of Li₁₊ₓMn_{2-y}O₄ spinel structured compounds”, Energy & Environmental Science (2010) vol. 3, page 1339-1346:

14.85 g of LiOH, H₂O were dissolved in 500 ml of water. 43.1 g of KMnO₄ were added to this solution and this liquid phase was poured into an autoclave. Under stirring, 28 ml of isobutyraldehyde and water were added until a total volume of 3.54 I was reached. The autoclave was subsequently heated to 180° C. and maintained at this temperature for 6 hours. After a slow cooling, a black precipitate was obtained in suspension in the solvent. This precipitate was subjected to a succession of centrifugation-redispersion steps in water, until an aggregated suspension was obtained with a conductivity of approximately 300 μS/cm and a zeta potential of −30 mV. The aggregates obtained consisted of aggregated primary particles of size of 10 to 20 nm. The aggregates obtained had a spherical shape and an average diameter of approximately 150 nm; they were characterised by x-ray diffraction and electron microscopy.

Approximately 10 to 15% by mass of polyvinylpyrrolidone (PVP) at 360,000 g/mol were subsequently added to the aqueous suspension of aggregates. The water was evaporated until the suspension of aggregates had a dry extract of 10%. The ink thus obtained was applied on a stainless steel strip (316 L) of a thickness of 5 μm. The layer obtained was dried in a temperature and humidity controlled oven in order to prevent the formation of cracks when drying. The ink deposition and drying was repeated to obtain a layer of approximately 10 μm of thickness.

This layer was consolidated at 600° C. for 1 h in air in order to bond the primary nanoparticles together, to improve the adherence to the substrate and to perfect the recrystallisation of the LiMn₂O₄. The porous layer thus obtained has an open porosity of approximately 45% by volume with pores of a size between 10 nm and 20 nm.

A thin layer of ZnO was subsequently deposited on and inside the pores of the mesoporous cathode based on LiMn₂O₄, in an ALD reactor of the P300B type (supplier: Picosun), under an argon pressure of 2 mbars at 180° C. Argon (Ar) was used here both as a carrier gas and for the purge. Before each deposition a drying time of 3 hours was applied. The precursors used were water and diethylzinc. A deposition cycle consisted of the following steps: Injecting diethylzinc, purging the chamber with Ar, injecting water, purging the chamber with Ar.

This cycle is repeated to reach a coating thickness of 1.5 nm. After these various cycles, the product was vacuum dried at 120° C. for 12 hours to eliminate the residues of reagents on the surface and thus to obtain a mesoporous cathode based on LiMn₂O₄ possessing over its entire accessible surface a coating of 1.5 nm of ZnO.

### Example 2: Production of a Mesoporous Anode Based on Li₄Ti₅O₁₂

A suspension of nanoparticles of Li₄Ti₅O₁₂ was prepared by glycothermal synthesis: 190 ml of 1,4-butanediol was poured into a beaker, and 4.25 g of lithium acetate was added under stirring. The solution was maintained under stirring until the acetate was completely dissolved. 16.9 g of titanium butoxide were taken under inert atmosphere and introduced into the acetate solution. The solution was subsequently stirred for a few minutes before being transferred into an autoclave filled beforehand with an additional 60 ml of butanediol. The autoclave was subsequently closed and purged with nitrogen for at least 10 minutes. The autoclave was subsequently heated to 300° C. at a speed of 3° C./min and maintained at this temperature for 2 hours, under stirring. At the end, it was left to cool, still under stirring.

A white precipitate was obtained in suspension in the solvent. This precipitate was subjected to a succession of centrifugation-redispersion steps in ethanol to obtain a pure colloidal suspension, with a low ionic conductivity. It included aggregates of approximately 150 nm consisting of primary particles of 10 nm. The zeta potential was in the order of −45 mV. The product was characterised by x-ray diffraction and electron microscopy.

These aggregates were deposited by electrophoresis on stainless steel strips of a thickness of 5 μm, in aqueous medium, by applying pulsed currents of 0.6 A at peak and 0.2 A on average; the voltage applied was in the order of 3 to 5 V for 500 s. A deposit of approximately 4 μm of thickness was thus obtained. It was consolidated by RTA annealing at 40% of power for 1 s in nitrogen in order to bond the nanoparticles together, to improve the adherence to the substrate and to perfect the recrystallisation of the Li₄Ti₅O₁₂.

A thin layer of SnO₂ was subsequently deposited on and inside the pores of the mesoporous anode based on Li₄Ti₅O₁₂.

1 g of polyvinylpyrrolidone (abbreviated PVP) of molecular mass by weight of 55,000 g/mol were added to 50 mL of distilled water at 40° C., then 3 g of tin oxalate SnC₂O₄ were added to this aqueous solution of PVP. The mesoporous anode based on Li₄Ti₅O₁₂ was subsequently immersed in this solution so that the tin oxalate can deposit on and inside the pores of the mesoporous anode based on Li₄Ti₅O₁₂. Subsequently, the electrode was dried then subjected to a heat treatment, preferably in nitrogen, at 600° C. for 5 h in such a way as to form a homogeneous coating of SnO₂ of 2 nm of thickness, over the entire accessible surface of the electrode, i.e. on and inside the pores of the anode and this, in a perfectly distributed way.

### Example 3: Manufacture of a Battery Using a Porous Cathode According to the Invention and a Porous Anode According to the Invention

a. Production of a Suspension of Nanoparticles of Li₃PO₄

Two solutions were prepared. 11.44 g of CH₃COOLi, 2H₂O were dissolved in 112 ml of water, then 56 ml of water were added under intense stirring to the medium in order to obtain a solution A. 4.0584 g of H₃PO₄ were diluted in 105.6 ml of water, then 45.6 ml of ethanol were added to this solution in order to obtain a second solution called hereinafter solution B.

Solution B was subsequently added, under intense stirring, to solution A. The solution obtained, perfectly limpid after the disappearance of bubbles formed during the mixing, was added to 1.2 litres of acetone under the action of a homogeniser of the Ultraturrax™ type in order to homogenise the medium. A white precipitation in suspension in the liquid phase was immediately observed.

The reaction medium was homogenised for 5 minutes then was maintained 10 minutes under magnetic stirring. It was left to decant for 1 to 2 hours. The supernatant was discarded then the remaining suspension was centrifuged 10 minutes at 6,000 rpm. Subsequently, 300 ml of water was added to put the precipitate back in suspension (use of a sonotrode, magnetic stirring). Under intense stirring, 125 ml of a solution of sodium tripolyphosphate at 100 g/l was added to the colloidal suspension thus obtained. The suspension thus became more stable. The suspension was subsequently sonicated with the aid of a sonotrode. The suspension was subsequently centrifuged 15 minutes at 8,000 rpm. The pellet was subsequently redispersed in 150 ml of water. Then the suspension obtained was again centrifuged 15 minutes at 8,000 rpm and the pellets obtained redispersed in 300 ml of ethanol in order to obtain a suspension capable of performing an electrophoretic deposition.

Agglomerates of approximately 100 nm consisting of primary particles of Li₃PO₄ of 10 nm were thus obtained in suspension in ethanol.

b. Production on the Anode and Cathode Layers Developed Beforehand of a Porous Inorganic Layer from the Suspension of Nanoparticles of Li₃PO₄ Described Above in Part a)

Thin porous layers of Li₃PO₄ were subsequently deposited by electrophoresis on the surface of the anode and cathode developed beforehand by applying an electric field of 20 V/cm to the suspension of nanoparticles of Li₃PO₄ obtained above, for 90 seconds to obtain a layer of a thickness of approximately 1.5 μm. This layer was dried in air at 120° C. in order to eliminate any trace of organic residues, and subsequently it was calcinated at 350° C. for one hour in air.

c. Production of an Electrochemical Cell

After having deposited 1.5 μm of porous Li₃PO₄ on each of the electrodes developed beforehand (see Examples 1 & 2), the two sub-systems were stacked in such a way that the films of Li₃PO₄ were in contact. This stack was subsequently vacuum hot pressed.

To do this, the stack was placed under a pressure of 1.5 MPa then vacuum dried for 30 minutes at 10⁻³ bars. The platens of the press were subsequently heated to 450° C. with a speed of 4° C./seconds. At 450° C., the stack was subsequently thermocompressed under a pressure of 45 MPa for 1 minute, then the system was cooled at ambient temperature.

Once the assembly was produced, a rigid, multilayer system consisting of one or more assembled battery cells was obtained.

This assembly was subsequently impregnated in an electrolytic solution comprising PYR14TFSI and LiTFSI at 0.7 M. The ionic liquid enters instantaneously by capillarity in the porosities. The system was maintained in immersion for 1 minute, then the surface of the stack of cells was dried by a curtain of N₂.

The invention claimed is:

1. A method for manufacturing a porous electrode for electrochemical devices, said porous electrode comprising a porous layer of at least one electrode active material P deposited on a substrate, and a layer of an electronically conductive oxide material present on and inside the pores of said porous layer, said porous electrode being free of binder, having a porosity between 20% and 60% by volume, and pores of average diameter smaller than 50 nm, the manufacturing method comprising:
(a) providing said substrate, said substrate is a substrate capable of acting as electric current collector, or an intermediate substrate, and providing a colloidal suspension or a paste, the colloidal suspension or the paste comprises aggregates or agglomerates of monodisperse primary nanoparticles of at least one electrode active material P, the primary nanoparticles of an average primary diameter D₅₀ between 2 nm and 150 nm, said aggregates or agglomerates have an average diameter D₅₀ between 50 nm and 300 nm,
(b) depositing a layer from said colloidal suspension or paste provided in step (a) on at least one face of said substrate, by a method selected in the group formed by: electrophoresis, extrusion, a printing method, a coating method,
(c) drying said layer obtained in step (b) and consolidating it, by heat and/or mechanical treatment, to obtain the porous layer, and
(d) forming a layer of an electronically conductive oxide material, on and inside the pores of said porous layer, in such a way as to form a porous layer coated with a layer of an electronically conductive oxide material.

2. The method for manufacturing a porous electrode according to claim 1, wherein in step (d), during step (d1), a layer of a precursor of an electronically conductive oxide material is deposited on and inside the pores of said porous layer, and during step (d2), the transformation of the precursor of an electronically conductive oxide material, deposited during step (d1) on said porous layer, into an electronically conductive material, is performed, in such a way that said porous layer has on and inside the pores, a layer of said electronically conductive oxide material.

3. The method for manufacturing a porous electrode according to claim 2, wherein step (d1) is carried out by immersion of the porous layer in a liquid phase including a precursor of said electronically conductive oxide material, and in that said transformation of the precursor of an electronically conductive oxide material into an electronically conductive material, during step (d2), is performed by heat treatment.

4. The method for manufacturing a porous electrode according to claim 3, wherein said precursor of the electronically conductive oxide material is selected from organic salts containing one or more metal elements capable, after heat treatment such as a calcination, of forming an electronically conductive oxide, and in wherein said transformation into electronically conductive material is a heat treatment, these organic salts being selected from:
an alcoholate of at least one metal element capable, after heat treatment, of forming the electronically conductive oxide,
an oxalate of at least one metal element capable, after heat treatment, of forming the electronically conductive oxide,
an acetate of at least one metal element capable, after heat treatment, of forming the electronically conductive oxide, and
wherein the at least one metal element is selected from tin, zinc, indium, gallium, or a mixture of two or three or four of these elements.

5. The method for manufacturing a porous electrode according to claim 1, wherein said electronically conductive oxide material is selected from:
tin oxide (SnO₂), zinc oxide (ZnO), indium oxide (In₂O₃), gallium oxide (Ga₂O₃), a mixture of two of these oxides, a mixture of three of these oxides or a mixture of four of these oxides,
doped oxides based on zinc oxide, the doping being with gallium (Ga) and/or with aluminium (Al) and/or with boron (B) and/or with beryllium (Be), and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped oxides based on indium oxide, the doping being with tin (Sn), and/or with gallium (Ga) and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped tin oxides, the doping being with arsenic (As) and/or with fluorine (F) and/or with nitrogen (N) and/or with niobium (Nb) and/or with phosphorus (P) and/or with antimony (Sb) and/or with aluminium (Al) and/or with titanium (Ti), and/or with gallium (Ga) and/or with chromium (Cr) and/or with cerium (Ce) and/or with indium (In) and/or with cobalt (Co) and/or with nickel (Ni) and/or with copper (Cu) and/or with manganese (Mn) and/or with germanium (Ge).

6. The method for manufacturing a porous electrode according to claim 1, wherein said porous layer obtained at the end of step (c) has a specific surface between 10 m²/g and 500 m²/g and/or a thickness between 4 μm and 400 μm.

7. The method for manufacturing a porous electrode according to claim 1, wherein when said substrate is the intermediate substrate, and step (c) is performed before or after having separated said layer from said substrate.

8. (canceled)

9. The method for manufacturing a porous electrode according to claim 1, wherein said electrode active material P is selected in the group formed by:
oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths comprising Sc, Y, Lu, La, Ce, Pr, Pm, Sm, Eu, Gd, Tb, Dy, Ho, Er, Tm, Yb, and where 0<x<0.1, LiMn₂₋ₓMₓO₄ with M=Er, Dy, Gd, Tb, Yb, Al, Y, Ni, Co, Ti, Sn, As, Mg or a mixture of these compounds and where 0<x<0.4, LiFeO₂, LiMn_{1/3}Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/2}O₂ with x+y+z=10;
LiₓM_{y}O₂ where 0.6≤y≤0.85; 0≤x+y≤2; and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
Li₁₊ₓNb_{y}Me_{z}AₚO₂ where Me is at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and where 0.6<x<1; 0<y<0.5; 0.25≤z<1; with A #Me and A #Nb, and 0≤p≤0.2;
LiₓNb_{y-a}NₐM_{z-b}PbO_{2-c}F_{c} where 1.2≤x≤1.75; 0≤y<0.55; 0.1≤z≤1; 0≤a<0.5; 0≤b<1; 0≤c≤0.8; and where M, N, and P are each at least one of the elements selected in the group consisting of Ti, Ta, V, Cr, Mn, Fe, Co, Ni, Cu, Zn, Al, Zr, Y, Mo, Ru, Rh, and Sb;
Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43}Ni_{0.27}O₂; Li_{1.3}Nb_{0.43}Co_{0.27}O₂; Li_{1.4}Nb_{0.2}Mn_{0.53}O₂;
LiₓNi_{0.2}Mn_{0.6}O_{y} where 0.00≤x≤1.52; 1.07≤y≤2.4; Li_{1.2}Ni_{0.2}Mn_{0.6}O₂;
LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z;
phosphates LiFePO₄, LiMnPO₄, LiCoPO₄, LiNiPO₄, Li₃V₂(PO₄)₃, Li₂MPO₄F with M=Fe, Co, Ni or a mixture of these various elements, LIMPO₄F with M=V, Fe, T or a mixture of these various elements; phosphates of formula LiMM′PO₄, with M and M′ (M≠M′) selected from Fe, Mn, Ni, Co, V, LiFeₓCo₁₋ₓPO₄ where 0<x<1;
Fe_{0.9}Co_{0.1}OF; LiMSO₄F with M=Fe, Co, Ni, Mn, Zn, Mg; and
all of the lithiated forms of the following chalcogenides: V₂O₅, V₃O₈, TiS₂, titanium oxysulfides (TiO_{y}S_{z} with z=2-y and 0.3≤y≤1), tungsten oxysulfides (WO_{y}S_{z} with 0.6<y<3 and 0.1<z<2), CuS, CuS₂,
LiₓV₂O₅ with 0<x≤2, LiₓV₃O₈ with 0<x≤1.7, LiₓTiS₂ with 0<x≤1, lithium and titanium oxysulfides LiₓTiO_{y}S_{z} with z=2-y, 0.3≤y≤1 and 0<x≤1, LiₓWO_{y}S_{z} with z=2-y, 0.3≤y≤1 and 0<x≤1, LiₓCuS with 0<x≤1, LiₓCuS₂ with 0<x≤1.

10. The method for manufacturing a porous electrode according to claim 1, wherein said electrode active material P is selected in the group formed by:
Li₄Ti₅O₁₂, Li₄Ti₅₋ₓMₓO₁₂ with M=V, Zr, Hf, Nb, Ta and 0≤x≤0.25;
niobium oxides and niobium oxides mixed with titanium, germanium, cerium or tungsten, from the group formed by:
Nb₂O_{5±δ}, Nb₁₈ W₁₆O_{93±δ}, Nb₁₆W₅O_{55±δ} with 0≤x≤1 and 0≤y≤2, LiNbO₃,
TiNb₂O_{7±δ}, Li_{w}TiNb₂O₇ with w>0, Ti₁₋ₓM¹ₓNb_{2-y}M²_{y}O_{7±δ} or Li_{w}Ti₁₋ₓM¹ₓNb_{2-y}M²_{y}O_{7±δ} wherein M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, M¹ and M² are identical to or different from one another, and wherein 0≤w≤5 and 0≤x≤1 and 0≤y≤2 and 0≤δ≤0.3;
LaₓTi₁₋₂ₓNb₂₊ₓO₇ where 0<x<0.5;
MₓTi₁₋₂ₓNb₂₊ₓO_{7±δ}
wherein M is an element the degree of oxidation of which is +III, and where 0<x≤0.20 and −0.3≤δ≤0.3; Ga_{0.10}Ti_{0.80}Nb_{2.10}O₇; Fe_{0.10}Ti_{0.80}Nb_{2.10}O₇;
MₓTi₂₋₂ₓNb₁₀₊ₓO_{29±δ}
wherein M is an element the degree of oxidation of which is +III, and where 0<x≤0.40 and −0.3≤δ≤0.3;
Ti₁₋ₓM¹ₓNb_{2-y}M²_{y}O_{7-z}M³₂ or Li_{w}Ti₁₋ₓM¹ₓNb_{2-y}M²_{y}O_{7-z}M³₂ wherein
M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
M¹ and M² are identical to or different from one another,
M³ is at least one halogen,
and wherein 0≤w≤5 and 0≤x≤1 and 0≤y≤2 and z≤0.3;
TiNb₂O_{7-z}M³_{z} or Li_{w}TiNb₂O_{7-z}M³₂ wherein M³ is at least one halogen, selected from F, Cl, Br, I or a mixture thereof, and 0<z≤0.3;
Ti₁₋ₓGeₓNb_{2-y}M¹_{y}O_{7+z}, Li_{w}Ti₁₋ₓGeₓNb_{2-y}M¹_{y}O_{7+z}, Ti₁₋ₓCeₓNb_{2-y}M¹_{y}O_{7+z}, Li_{w}Ti₁₋ₓCeₓNb_{2-y}M¹_{y}O_{7+z} wherein
M¹ is at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn;
0≤w≤5 and 0≤x≤1 and 0≤y≤2 and z≤0.3;
Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓCeₓNb_{2-y}M¹_{y}O_{7-z}M²_{z}, Li_{w}Ti₁₋ₓCeₓNb_{2-y}M¹_{y}O_{7-z}M²_{z}, wherein
M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
M¹ and M² are identical to or different from one another,
and wherein 0≤w≤5 and 0≤x≤1 and 0≤y≤2 and z≤0.3;
TiO₂; TiOₓN_{y} with x<2 and 0<y<0.2;
LiSiTON, silicon- and tin-based oxynitrides, and the formulation SiSn_{0.87}O_{1.20}N_{1.72} and their lithiated forms;
nitrides and oxynitrides of the MOₓN_{y} type where M is at least one element selected from Ge, Si, Sn, Zn or a mixture of one or more of these elements, and where x≥0 and y≥0.3;
Li₃₋ₓMₓN with M is at least one element selected from Cu, Ni, Co or a mixture of one or more of these elements;
Li₃₋ₓMₓN with M being cobalt (Co) and 0<x<0.5; Li₃₋ₓMₓN with M being nickel (Ni) and 0≤x≤0.6; Li₃₋ₓMₓN with M being copper (Cu) and 0≤x≤0.3;
carbon nanotubes, graphene, graphite;
lithiated iron phosphate, of typical formula LiFePO₄;
mixed silicon and tin oxynitrides (SiTON) of typical formula SiₐSn_{b}O_{y}N_{z} with a>0, b>0, a+b≤2, 0<y≤4, 0<z≤3; and SiSn_{0.87}O_{1.2}N_{1.72}; as well as oxynitrides-carbides of typical formula SiₐSn_{b}C_{c}O_{y}N_{z} with a>0, b>0, a+b≤2, 0≤c≤10, 0≤y≤24, 0≤z≤17;
nitrides of the SiₓN_{y} type, with x=3 and y=4; SnₓN_{y}, with x=3 and y=4, ZnₓN_{y}, with x=3 and y=2; Li₃₋ₓMₓN with 0≤x≤0.5 for M=Co, 0≤x≤0.6 for M=Ni, 0≤x≤0.3 for M=Cu; Si₃₋ₓMₓN₄ with M=Co or Fe and 0≤x≤3,
oxides SnO₂, SnO, Li₂SnO₃, SnSiO₃, LiₓSiO_{y} with x>=0 and 2>y>0, Li₄Ti₅O₁₂, TiNb₂O₇, Co₃O₄, SnB_{0.6}P_{0.4}O_{2.9} and TiO₂,
composite oxides TiNb₂O₇ comprising between 0% and 10% by weight of carbon.

11. (canceled)

12. A porous electrode, for electrochemical devices, comprising a porous layer of at least one electrode active material P deposited on a substrate, and a layer of an electronically conductive oxide material disposed on and inside the pores of said porous layer, in that it is free of binder, that it has a porosity between 20% and 60% by volume, and pores of average diameter smaller than 50 nm.

13. The porous electrode according to claim 12, wherein said electronically conductive oxide material is selected from:
tin oxide (SnO₂), zinc oxide (ZnO), indium oxide (In₂O₃), gallium oxide (Ga₂O₃), a mixture of two of these oxides, a mixture of three of these oxides or a mixture of four of these oxides,
doped oxides based on zinc oxide, the doping being with gallium (Ga) and/or with aluminium (Al) and/or with boron (B) and/or with beryllium (Be), and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped oxides based on indium oxide, the doping being with tin (Sn), and/or with gallium (Ga) and/or with chromium (Cr) and/or with cerium (Ce) and/or with titanium (Ti) and/or with indium (In) and/or with cobalt (Co) and/or with nickel (Ni) and/or with copper (Cu) and/or with manganese (Mn) and/or with germanium (Ge),
doped tin oxides, the doping being with arsenic (As) and/or with fluorine (F) and/or with nitrogen (N) and/or with niobium (Nb) and/or with phosphorus (P) and/or with antimony (Sb) and/or with aluminium (Al) and/or with titanium (Ti), and/or with gallium (Ga) and/or with chromium (Cr) and/or with cerium (Ce) and/or with indium (In) and/or with cobalt (Co) and/or with nickel (Ni) and/or with copper (Cu) and/or with manganese (Mn) and/or with germanium (Ge).

14. The porous electrode according to claim 12, wherein said electrode active material P is selected in the group formed by:
oxides LiMn₂O₄, Li₁₊ₓMn₂₋ₓO₄ with 0<x<0.15, LiCoO₂, LiNiO₂, LiMn_{1.5}Ni_{0.5}O₄, LiMn_{1.5}Ni_{0.5-x}XₓO₄ where X is selected from Al, Fe, Cr, Co, Rh, Nd, other rare earths comprising Sc, Y, Lu, La, Ce, Pr, Pm, Sm, Eu, Gd, Tb, Dy, Ho, Er, Tm, Yb, and where 0<x<0.1, LiMn₂₋ₓMₓO₄ with M=Er, Dy, Gd, Tb, Yb, Al, Y, Ni, Co, Ti, Sn, As, Mg or a mixture of these compounds and where 0≤x<0.4, LifeO₂, LiMn_{1/3} Ni_{1/3}Co_{1/3}O₂, LiNi_{0.8}Co_{0.15}Al_{0.05}O₂, LiAlₓMn₂₋ₓO₄ with 0≤x<0.15, LiNi_{1/x}Co_{1/y}Mn_{1/2}O₂ with x+y+z=10;
LiₓM_{y}O₂ where 0.6≤y≤0.85; 0≤x+y≤2; and M is selected from Al, Ti, Cr, Mn, Fe, Co, Ni, Cu, Zn, Zr, Nb, Mo, Ru, Sn, and Sb or a mixture of these elements; Li_{1.20}Nb_{0.20}Mn_{0.60}O₂;
Li₁₊ₓNb_{y}Me_{z}AₚO₂ where Me is at least one transition metal selected from: Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, and where 0.6<x<1; 0<y<0.5; 0.25≤z<1; with A #Me and A #Nb, and 0≤p≤0.2;
LiₓNb_{y-a}NₐM_{z-b}PbO_{2-c}F_{c} where 1.2≤x<1.75; 0≤y<0.55; 0.1≤z<1; 0≤a<0.5; 0≤b<1; 0≤c<0.8; and where M, N, and P are each at least one of the elements selected in the group consisting of Ti, Ta, V, Cr, Mn, Fe, Co, Ni, Cu, Zn, Al, Zr, Y, Mo, Ru, Rh, and Sb;
Li_{1.25}Nb_{0.25}Mn_{0.50}O₂; Li_{1.3}Nb_{0.3}Mn_{0.40}O₂; Li_{1.3}Nb_{0.3}Fe_{0.40}O₂; Li_{1.3}Nb_{0.43}Ni_{0.27}O₂;
Li_{1.3}Nb_{0.43}Co_{0.27}O₂; Li_{1.4}Nb_{0.2}Mn_{0.53}O₂;
LiₓNi_{0.2}Mn_{0.6}O_{y} where 0.00≤x≤1.52; 1.07≤y<2.4; Li_{1.2}Ni_{0.2}Mn_{0.6}O₂;
LiNiₓCo_{y}Mn_{1-x-y}O₂ where 0≤x and y≤0.5; LiNiₓCe_{z}Co_{y}Mn_{1-x-y}O₂ where 0≤x and y≤0.5 and 0≤z;
phosphates LiFePO₄, LiMnPO₄, LiCoPO₄, LiNiPO₄, Li₃V₂(PO₄)₃, Li₂MPO₄F with M=Fe, Co, Ni or a mixture of these various elements, LIMPO₄F with M=V, Fe, T or a mixture of these various elements; phosphates of formula LiMM′PO₄, with M and M′ (M≠M′) selected from Fe, Mn, Ni, Co, V, LiFeₓCo₁₋ₓPO₄ where 0<x<1;
Fe_{0.9}Co_{0.1}OF; LiMSO₄F with M=Fe, Co, Ni, Mn, Zn, Mg; and
all of the lithiated forms of the following chalcogenides: V₂O₅, V₃O₈, TiS₂, titanium oxysulfides (TiO_{y}S_{z} with z=2-y and 0.3≤y≤1), tungsten oxysulfides (WO_{y}S_{z} with 0.6<y<3 and 0.1<z<2), CuS, CuS₂,
LiₓV₂O₅ with 0<x≤2, LiₓV₃O₈ with 0<x≤1.7, LiₓTiS₂ with 0<x≤1, lithium and titanium oxysulfides LiₓTiO_{y}S_{z} with z=2-y, 0.3≤y≤1 and 0<x≤1, LiₓWO_{y}S_{z} with z=2-y, 0.3≤y≤1 and 0<x≤1, LiₓCuS with 0<x≤1, LiₓCuS₂ with 0<x≤1.

15. The porous electrode according to claim 12, wherein said electrode active material P is selected in the group formed by:
Li₄Ti₅O₁₂, Li₄Ti₅₋ₓMₓO₁₂ with M=V, Zr, Hf, Nb, Ta and 0≤x≤0.25;
niobium oxides and niobium oxides mixed with titanium, germanium, cerium or tungsten, from the group formed by:
Nb₂O_{5±δ}, Nb₁₈W₁₆O_{93±δ}, Nb₁₆W₅O_{55±δ} with 0≤x<1 and 0≤8≤2, LiNbO₃,
TiNb₂O_{7±δ}, LiwTiNb₂O₇ with w>0, Ti₁₋ₓM¹ₓNb_{2-y}M²_{y}O_{7±δ} or Li_{w}Ti₁₋ₓM¹ₓNb_{2-y}M²_{y}O_{7±δ} wherein M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn, M¹ and M² are identical to or different from one another, and wherein 0≤w≤5 and 0≤x≤1 and 0≤y≤2 and 0≤8≤0.3;
LaₓTi₁₋₂ₓNb₂₊ₓO₇ where 0<x<0.5;
MₓTi₁₋₂ₓNb₂₊ₓO_{7±δ}
wherein M is an element the degree of oxidation of which is +III, and where 0<x≤0.20 and −0.3≤δ≤0.3; Ga_{0.10}Ti_{0.80}Nb_{2.10}O₇; Fe_{0.10}Ti_{0.80}Nb_{2.10}O₇;
MₓTi₂₋₂ₓNb₁₀₊ₓO_{29±δ}
wherein M is an element the degree of oxidation of which is +III, and where 0<x≤0.40 and −0.3≤δ≤0.3;
Ti₁₋ₓM¹ₓNb_{2-y}M²_{y}O₇₋₂M³_{z} or Li_{w}Ti₁₋ₓM¹ₓNb_{2-y}M²_{y}O_{7-z}M³_{z} wherein
M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn,
M¹ and M² are identical to or different from one another,
M³ is at least one halogen,
and wherein 0≤w≤5 and 0≤x≤1 and 0≤y≤2 and z≤0.3;
TiNb₂O_{7-z}M³_{z} or Li_{w}TiNb₂O_{7-z}M³_{z} wherein M³ is at least one halogen, selected from F, Cl, Br, I or a mixture thereof, and 0<z≤0.3;
Ti₁₋ₓGeₓNb_{2-y}M¹_{y}O_{7±z}, Li_{w}Ti₁₋ₓGeₓNb_{2-y}M¹_{y}O_{7±z}, Ti₁₋ₓCeₓNb_{2-y}M¹_{y}O_{7±z}, Li_{w}Ti₁₋ₓCeₓNb_{2-y}M¹_{y}O_{7±z} wherein
M¹ is at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs and Sn;
0≤w≤5 and 0≤x≤1 and 0≤y≤2 and z≤0.3;
Ti₁₋ₓGeₓNb_{2-y}M¹_{y}O_{7-z}M²_{z}, Li_{w}Ti₁₋ₓGeₓNb_{2-y}M¹_{y}O_{7-z}M²_{z}, Ti₁₋ₓCeₓNb_{2-y}M¹_{y}O_{7-z}M²_{z}, Li_{w}Ti₁₋ₓCeₓNb_{2-y}M¹_{y}O_{7-z}M²_{z}, wherein
M¹ and M² are each at least one element selected in the group consisting of Nb, V, Ta, Fe, Co, Ti, Bi, Sb, As, P, Cr, Mo, W, B, Na, Mg, Ca, Ba, Pb, Al, Zr, Si, Sr, K, Cs, Ce and Sn,
M¹ and M² are identical to or different from one another,
and wherein 0≤w≤5 and 0≤x≤1 and 0≤y≤2 and z≤0.3;
TiO₂; TiOₓN_{y} with x<2 and 0<y<0.2;
LiSiTON, silicon- and tin-based oxynitrides, and the formulation SiSn_{0.87}O_{1.20}N_{1.72} and their lithiated forms;
nitrides and oxynitrides of the MOₓN_{y} type where M is at least one element selected from Ge, Si, Sn, Zn or a mixture of one or more of these elements, and where x≥0 and y≥0.3;
Li₃₋ₓMₓN with M is at least one element selected from Cu, Ni, Co or a mixture of one or more of these elements;
Li₃₋ₓMₓN with M being cobalt (Co) and 0=x≤0.5; Li₃₋ₓMₓN with M being nickel (Ni) and 0≤x≤0.6; Li₃₋ₓMₓN with M being copper (Cu) and 0≤x≤0.3;
carbon nanotubes, graphene, graphite;
lithiated iron phosphate, of typical formula LiFePO₄;
mixed silicon and tin oxynitrides (SiTON) of typical formula SiₐSₙO_{y}N_{z} with a>0, b>0, a+b≤2, 0<y≤4, 0<z≤3; and SiSn_{0.87}O_{1.2}N_{1.72}; as well as oxynitrides-carbides of typical formula SiₐSn_{b}C_{c}O_{y}N_{z} with a>0, b>0, a+b≤2, 0<c<10, 0<y<24, 0<z<17;
nitrides of the SiₓN_{y} type, with x=3 and y=4; SnₓN_{y}, with x=3 and y=4, ZnₓN_{y}, with x=3 and y=2; Li₃₋ₓMₓN with 0≤x≤0.5 for M=Co, 0≤x≤0.6 for M=Ni, 0≤x≤0.3 for M=Cu; Si₃₋ₓMₓN₄ with M=Co or Fe and 0≤x≤3,
oxides SnO₂, SnO, Li₂SnO₃, SnSiO₃, LiₓSiO_{y} with x>=0 and 2>y>0, Li₄Ti₅O₁₂, TiNb₂O₇, Co₃O₄, SnB_{0.6}P_{0.4}O_{2.9} and TiO₂,
composite oxides TiNb₂ O₇ comprising between 0% and 10% by weight of carbon.

16. A method for manufacturing an electronic or electrochemical device, implementing the method for manufacturing a porous electrode according to claim 1.

17. (canceled)

18. (canceled)

19. The method for manufacturing a battery according to claim 16, wherein said porous electrode is impregnated with an electrolyte.

20. A electronic or electrochemical device obtainable by the method for manufacturing an electronic or electrochemical device according to claim 16.

21. The device according to claim 20, wherein the device is selected in the group formed by: the lithium-ion batteries, the capacitors, the supercapacitors, the photovoltaic cells, the photoelectrochemical cells.

22. (canceled)

23. (canceled)

24. (canceled)

25. The method for manufacturing a battery according to claim 19, wherein the electrolyte is a lithium-ion carrier phase selected in the group formed by:
an electrolyte consisting of at least one aprotic solvent and of at least one lithium salt;
an electrolyte consisting of at least one ionic liquid and of at least one lithium salt;
a mixture of at least one aprotic solvent and of at least one ionic liquid and of at least one lithium salt;
a polymer made ionically conductive by adding at least one lithium salt; and
a polymer made ionically conductive by adding a liquid electrolyte, either in the polymer phase, or in the mesoporous structure.
